(19) United States
(12) Patent Application Publication
(10) Pub. No.: US 2009/0056589 A1
(43) Pub. Date: Mar. 5, 2009

(54) TRANSPARENT CONDUCTORS HAVING STRETCHED TRANSPARENT CONDUCTIVE COATINGS AND METHODS FOR FABRICATING THE SAME

(75) Inventors: James V. Guiheen, Madison, NJ (US); Yuan-Ping R. Ting, Plainsboro, NJ (US); Gary L. Martin, Piscataway, NJ (US); Yubing Wang, Piscataway, NJ (US); Kwok Wai Lem, Randolph, NJ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/846,682

(22) Filed: Aug. 29, 2007

(51) Int. Cl. C09D 4/00; B05D 3/12

(52) U.S. Cl. 106/285; 106/287.2; 106/287.23; 106/287.24; 106/287.26; 106/287.3; 427/171

(57) ABSTRACT

Transparent conductors and methods for fabricating transparent conductors are provided. A method for fabricating a transparent conductor comprises providing a stretchable transparent substrate. A dispersion comprising a plurality of conductive elements and a solvent is formed. The dispersion is applied overlying the stretchable transparent substrate. The solvent is at least partially evaporated to form a transparent conductive coating on the stretchable transparent substrate and the substrate and the transparent conductive coating are stretched.

### FIELD OF THE INVENTION

The present invention generally relates to transparent conductors and methods for fabricating transparent conductors, and more particularly relates to transparent conductors having stretched transparent conductive coatings and methods for fabricating transparent conductors having stretched transparent conductive coatings.

### BACKGROUND OF THE INVENTION

Over the past a few years, there has been an explosive growth of interest in research and industrial applications for transparent conductors. A transparent conductor typically includes a transparent substrate upon which is disposed a coating or film that is transparent yet electrically conductive. This unique class of conductors is used, or is considered being used, in a variety of applications, such as solar cells, antistatic films, gas sensors, organic light-emitting diodes, liquid crystal and high definition displays, and electrochromic and smart windows, as well as architectural coatings.

Transparent conductor films generally are manufactured by applying to or forming on a flat glass or a flat transparent polymer substrate a relatively thin transparent conductive coating. When the desired substrate is a polymeric film, the polymeric film typically is processed by sheet or film extrusion, blown-film extrusion, or solution or melt casting. In the typical film extrusion process, the polymeric materials, in pellet and/or powdered raw material form, are typically carried by a screw into a heating area, and then are forced out through a die orifice. Typical film extruder orifices are either tubular or rectangular in cross section. For tubular extrusions, tube diameters can be several inches to a few feet in diameter. To create flat or rectangular non-tubular films from tubular films, the tubular extrusion can be cut either before or after being expanded to a larger size. For rectangular extruders, a flat rectangular extrusion is generally produced, and the extrusion cross section can be quite thin (for example, fractions of an inch) and wide (for example, several feet). After the film is extruded to a controlled shape, it is cooled to a desired temperature, usually below its melting point and above its glass transition temperature. The film subsequently can be stretched to control the shape and the properties of the polymer. Flat rectangular films can be stretched in either the machine direction (uniaxially) or in both machine and side-way directions (biaxially) using a tenter frame. Tubular films can be stretched multiaxially using pressurized gas maintained within the tubular extrusion. Hereinafter, uniaxial, biaxial, and multiaxial film deformation of this type and any derivations thereof are referred to as “stretching.” The transparent conductive coating then may be applied to the stretched polymer.

From a manufacturing perspective, it would be more cost efficient to form a transparent conductor film in an efficient on-line process that allows for the application of the transparent conductive coating to the polymer substrate after the polymer substrate is extruded through the extrusion die but before any subsequent stretching, rather than after the polymer substrate is stretched. However, only certain classes of transparent conductive coatings are stretchable and these often suffer from distinct drawbacks. For example, ionic-chemical based coatings, such as ethoxylated fatty amines, fatty acid esters, ethyleneamines, quaternary ammonium salts, sulfonated hydrocarbons, and polyalkylene oxide esters, while stretchable, operate poorly in low humidity conditions and typically have high vapor pressures that result in loss of function over time. Stretchable graphite-based coatings suffer from poor transparency at high loading, low conductivity at low loading, sloughing damage that reduces performance, and contamination issues that cause difficulties in clean room environments.

Inherently conductive polymers such as polythiophenes, polyanalines, and polypyrroles have also been considered for transparent conductor applications. However, polyanalines and polypyrroles are typically vacuum deposited and are very water sensitive. Polythiophenes undergo optically detrimental changes when subjected to the thermal and mechanical environment used to stretch polymeric film.

Accordingly, it is desirable to provide transparent conductors that have stretched transparent conductive coatings. It is also desirable to provide methods for fabricating transparent conductors that utilize an efficient on-line process. In addition, it is desirable to provide methods for fabricating transparent conductors with stretched transparent conductive coatings that are highly transparent and conductive under various loading conditions, and that operate satisfactorily in both high-humidity and low-humidity environments. It further is desirable to provide a dispersion useful for fabricating transparent conductors with stretched transparent conductive coatings. Moreover, it is desirable to provide methods for fabricating transparent conductors with transparent conductive coatings that do not raise sloughing or contamination issues. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method for fabricating a transparent conductor in accordance with an exemplary embodiment of the present invention is provided. The method comprises providing a stretchable transparent substrate. A dispersion comprising a plurality of conductive elements and a solvent is formed and is applied overlying the stretchable transparent substrate. The solvent is at least partially evaporated from the dispersion to form a transparent conductive coating on the stretchable transparent substrate and the stretchable transparent substrate and the transparent conductive coating are stretched.

A composition for fabricating a stretchable transparent conductive coating on a stretchable substrate in accordance with an exemplary embodiment of the present invention is provided. The composition comprises a plurality of carbon nanotubes and a solvent.

A transparent conductor in accordance with an exemplary embodiment of the present invention is provided. The transparent conductor comprises a stretched substrate and a stretched transparent conductive coating overlying the stretched substrate.

### BRIEF DESCRIPTION OF THE DRAWINGS

The present invention will hereinafter be described in conjunction with the following drawing figures, wherein like numerals denote like elements, and wherein:

FIG. 1 is a side view of a transparent conductor in accordance with an exemplary embodiment of the present invention; and

FIG. 2 is a flowchart of a method for fabricating the transparent conductor of FIG. 1 in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

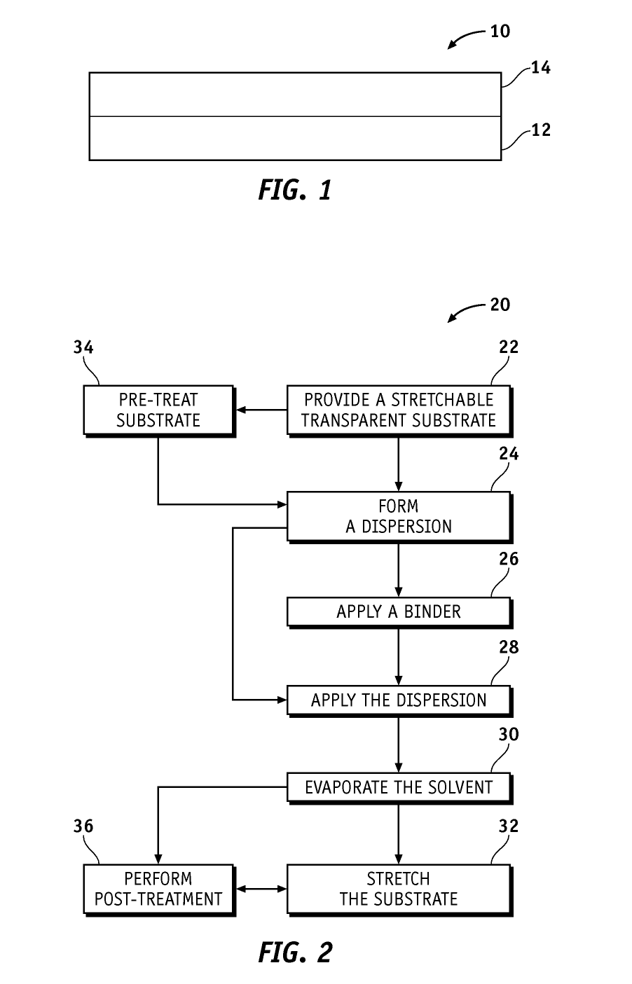

A transparent conductor 10 in accordance with an exemplary embodiment of the present invention is illustrated in FIG. 1. The transparent conductor 10 comprises a stretched transparent substrate 12, that is, a substrate that has been stretched from a first thickness to a second thickness that is less than the first thickness. A stretched transparent conductive coating 14 is disposed on the stretched transparent substrate 12. The transparency of a transparent conductor can be defined by its light transmittance (ASTM D1003), that is, the percentage of incident light transmitted through the conductor. In one exemplary embodiment of the invention, the transparent conductor 10 has a total light transmittance of no less than about 50%. The light transmittance of the transparent substrate 12 can be less than, equal to, or greater than the light transmittance of the transparent conductive coating 14. In another exemplary embodiment of the invention, the transparent conductor 10 has a surface resistivity in the range of about 10¹ to about 10¹² ohms/square (Ω/sq). In another exemplary embodiment of the invention, the transparent conductor 10 has a surface resistivity in the range of about 10⁷ to about 10⁸ Ω/sq. In this regard, the transparent conductor 10 may be used in various applications such as static discharge films, touch panels, electroluminescent lamp electrodes, and the like.

Referring to FIG. 2, a method 20 for fabricating a transparent conductor, such as the transparent conductor 10 of FIG. 1, comprises an initial step of providing a stretchable transparent substrate (step 22). The stretchable transparent substrate may comprise any stretchable transparent polymer. As used herein, the term “stretchable” material means a material that can have its length, width, or both extended, lengthened, or otherwise increased under physical force, with at least a portion of its thickness decreased, with no more than a negligible change to its molecular structural and chemical properties. In one exemplary embodiment of the invention, the transparent substrate has a total light transmittance no less than about 80%. Examples of stretchable transparent polymers suitable for use as a transparent substrate include thermoplastics and thermosetting resins of homopolymers, copolymers, grafted polymers, polymer blends, polymer alloys and combinations thereof. These materials can be crystalline, semicrystalline, or amorphous with flexible backbone structures (soft segments), rigid backbone structures (hard segments), or combinations thereof. These include polyesters such as polyethylene terephthalate (PET) and polyethylene naphthalate (PEN), polyolefins, particularly the metallocened polyolefins, such as polypropylene (PP) and high-density polyethylene (HDPE) and low-density polyethylene (LDPE), polyvinyls such as plasticized polyvinyl chloride (PVC), polyvinylidene chloride, cellulose ester bases such as triacetate cellulose (TAC) and acetate cellulose, polycarbonates, poly(vinyl acetate) and its derivatives such as poly(vinyl alcohol), acrylic and acrylate polymers such as methacrylate polymers, poly(methyl methacrylate) (PMMA), methacrylate copolymers, polyamides and polyimides, polyacetals, phenolic resins, aminoplastics such as urea-formaldehyde resins, and melamine-formaldehyde resins, epoxide resins, urethanes and polyisocyanurates, furan resins, silicones, casesin resins, and other cyclic thermoplastics such as cyclic olefin polymers, styrenic polymers, fluorine-containing polymers, polyethersulfone, and polyimides containing an alicyclic structure.

In an optional embodiment of the present invention, the substrate can be pretreated to facilitate the deposition of components of the transparent conductive coating, discussed in more detail below, and/or to facilitation adhesion of the components to the substrate (step 34). The pretreatment may comprise a solvent or chemical washing, heating, or surface treatments such as plasma treatment, UV-ozone treatment, or flame or corona discharge. Alternatively, or in combination, an adhesive (also called a primer) may be deposited onto the surface of the substrate to further improve adhesion of the components to the substrate.

Before, during, or after the step of providing the substrate, a dispersion comprising a plurality of conductive elements and a solvent is formed (step 24). The conductive elements are discrete structures that are capable of conducting electrons such as, for example, one or more of conductive nanotubes, conductive nanowires, and any conductive nanoparticles. In one exemplary embodiment of the present, the conductive elements are multi-walled and/or single-walled carbon nanotubes. The carbon nanotubes suitable for use in the dispersion may be formed by any known methods in the art such as laser ablation, chemical vapor deposition (CVD), arc discharge, and the like. The carbon nanotubes preferably have minimal or no metal impurities or carbonaceous impurities that are not carbon nanotubes such as graphite, amorphous, and diamond carbonaceous impurities and non-tubular fullerenes. The transparency of the resulting transparent conductive coating increases with reduced levels of metallic and carbonaceous impurities. In one exemplary embodiment of the present invention, where a resistivity of less than 1×10⁹ Ω/sq is achieved with a total light transmittance of greater than 80%, the carbon nanotubes have an average length of no less than about 1 to about 50 microns (μm). In a preferred exemplary embodiment, the carbon nanotubes have an average length in the range of about 1 to about 10 μm. In a further embodiment of the present invention, the carbon nanotubes have an average diameter in the range of about 1 to about 10 nm. In yet another embodiment, the nanotubes have a length-to-diameter ratio, that is, an aspect ratio, of about 500 to about 5000.

In another exemplary embodiment of the invention, the conductive elements are metal or metal-comprising nanowires. Examples of metal nanowires suitable for use as conductive elements include, but are not limited to, nanowires made from silver (Ag), gold (Au), copper (Cu), nickel (Ni), titanium (Ti), tantalum (Ta), and the like. Examples of metal-comprising nanowires include, but are not limited to, metal oxide nanowires, such as indium tin oxide (“ITO”) nanowires, zinc oxide (ZnO) nanowires, and the like. In one embodiment of the present invention, the nanowires have an average length of no less than about 1 μm, as longer nanowires typically conduct better than shorter nanowires. In further embodiment of the present invention, the nanowires have an average diameter in the range of about 40 to about 100 nm. In yet another embodiment, the nanowires have an aspect ratio of about 100:1 to greater than about 1000:1.

Solvents suitable for use in the dispersion comprise any non-corrosive, volatile liquid that is capable of dispersing the conductive elements into a stable dispersion. In a preferred embodiment of the invention, the solvent has a boiling point of no greater than about 250° C. In a more preferred embodiment of the invention, the solvent has a boiling point of no greater than about 100° C. Examples of suitable solvents include water, alcohols (such as isopropanol), ketones (such as acetone and methylethyl ketone), toluene, hexane, dimethylformamide, tetrahydrofuran, acetates (such as ethyl acetate), ethers, hydrocarbons, aromatic solvents (such as xylene), n-methylpyrrolidone, propylene glycol monomethyl ether (PGME), propylene glycol methyl ether acetate (PGMEA), and the like, and combinations thereof.

To form the dispersion, at least one type of conductive element and at least one solvent are combined to form a homogeneous mixture. In one exemplary embodiment of the invention, the conductive elements comprise about 0.01% to about 1% by weight of the total dispersion. In a preferred embodiment of the invention, the conductive elements comprise about 0.1% by weight of the dispersion. The dispersion may be formed using any suitable mixing or stirring process. For example, a sonicator or a high shear mixing apparatus, such as a homogenizer, a microfluidizer, a cowls blade high shear mixer, an automated media mill, or a ball mill, may be used for several minutes to an hour or more to form the dispersion. Heat also may be used to facilitate formation of the dispersion. In addition to the conductive elements and the solvent, the dispersion may comprise one or more “functional” additives. The term “functional” as used herein means that the additive can be used to control viscosity, corrosion, adhesion, dispersion, wetting, drag-reduction, rheology, or the like, or that further facilitate dispersion. Examples of such additives include dispersants, surfactants, polymerization inhibitors, corrosion inhibitors, light stabilizers, wetting agents, adhesion promoters, viscosifiers, rheology modifiers, thickeners, antifoaming agents, detergents, flame retardants, pigments, plasticizers, and the like. In one exemplary embodiment, the dispersion comprises a wetting agent, preferably Stahl LA 161 wetting agent available from Stahl USA of Peabody, Mass.

Once formed, the dispersion is applied to a surface of the substrate to a desired thickness (step 28). The dispersion may be applied by, for example, brushing, painting, screen printing, stamp rolling, or spraying the combination onto the substrate, dip-coating the substrate into the dispersion, rolling the dispersion onto substrate, or by any other method or combination of methods that permits the dispersion to be applied uniformly or substantially uniformly to the surface of the substrate. As described in more detail below, because the transparent conductive coating resulting from the dispersion will be stretched, it is preferred that the dispersion is applied with a greater thickness so that, once stretched, the coating has a smaller, predetermined thickness.

In another exemplary embodiment of the present invention, the method 20 continues after formation of the dispersion (step 24) by applying a stretchable transparent binder to the substrate (step 26) and applying the dispersion to the substrate (step 28). In one exemplary embodiment of the invention, such as when the conductive elements comprise carbon nanotubes, these steps (step 26 and step 28) are performed simultaneously or substantially simultaneously, as the dispersion and the stretchable binder are combined and the combination is applied to the substrate. As used herein, the term “binder” refers to a polymer material that is used to provide enhanced adhesion between the conductive elements and the polymer substrate and may also be referred to as “primer” or “resin”. Examples of stretchable transparent binders suitable for use in the dispersion/binder combination include any non-corrosive material that facilitates adhesion of the conductive elements to the substrate. In one exemplary embodiment, the binder comprises polyurethanes, urethanes, polyisocyanurates, polyesters, polyolefins, polyvinyl chloride, polyvinylidene chloride, cellulose ester, polycarbonates, poly(vinyl acetate), poly(vinyl alcohol), acrylic and acrylate polymers, polyamides and polyimides, polyacetals, phenolic resins, aminoplastics epoxide resins, furan resins, silicones, casesin resins, and other cyclic thermoplastics, styrenic polymers, fluorine-containing polymers, polyethersulfone, and polyimides containing an alicyclic structure. In a preferred embodiment of the invention, the stretchable transparent binder is a water-based polyurethane emulsion formed from an aliphatic polyester polyol and an aliphatic polyisocyanate such as IPDI-isophorone diisocyanate. An example of such a water-based polyurethane emulsion is Stahl Product Code EX-66-866 available from Stahl USA. The dispersion/binder combination may be formed using any known stirring or mixing method that provides for a homogenous mixture, such as those methods described above. Heat also may be used to facilitate formation of the dispersion/binder combination.

Once formed, the dispersion/binder combination is applied to a surface of the substrate to a desired thickness. The dispersion/binder combination may be applied by, for example, brushing, painting, screen printing, stamp rolling, or spraying the combination onto the binder, dip-coating the substrate into the combination, rolling the combination onto substrate, or by any other method or combination of methods that permits the dispersion/binder combination to be applied uniformly or substantially uniformly to the surface of the substrate. As described in more detail below, because the transparent conductive coating resulting from the dispersion/binder combination will be stretched, it is preferred that the combination is applied with a greater thickness so that, once stretched, the coating has a smaller, predetermined thickness.

In another exemplary embodiment of the invention, such as when the conductive elements comprise metal or metal-comprising nanowires, the binder can be applied to the substrate first, followed by application of the dispersion to the binder. In this regard, a higher degree of conductivity may be obtained from the nanowires. Examples of suitable stretchable transparent binders include any of the non-corrosive binders described above. The binder and the dispersion are applied uniformly using any of the methods described above for application of a dispersion/binder combination. Again, because the transparent conductive coating resulting from the binder and dispersion will be stretched, it is preferred that the binder and/or the dispersion are applied with greater thicknesses so that, once stretched, the resulting transparent conductive coating has a smaller, predetermined thickness. In this regard, the dispersion may be applied to the binder with a thickness that is greater than, equal to, or less than the thickness of the binder.

The use of conductive elements, such as nanowires, nanotubes, and nanoparticles, and the above-identified stretchable dispersions, and optional stretchable binders, permits the fabrication of a transparent conductor that operates consistently in high and low humidity conditions and that does not exhibit a loss of function over time due to changing vapor pressures. Further, the resulting transparent conductor does not suffer from sloughing damage and does not present contamination issues.

Once the dispersion is applied, either directly to the substrate or as a dispersion/binder combination or to the binder overlying the substrate, the solvent in the dispersion is evaporated (step 30). In this regard, the dispersion may be permitted to evaporate at room temperature (about 16° C. to about 28° C.) or may be heated to the boiling point of the solvent for a sufficient time to permit the solvent to evaporate. Before, during, or after evaporation of the solvent, the binder can be cured. The curing process is dependent on the binder and may comprise, for example, allowing the binder to cure at room temperature for a suitable time or heating the binder until cured, or subjecting the binder to light.

After at least partial evaporation of the solvent, the resulting transparent conductive coating can be post-treated to improve the transparency and/or conductivity of the coating (step 36). In one exemplary embodiment, the transparent conductive coating can be treated with an alkaline, including treated with a strong base. Strong bases suitable for such treatments include hydroxide constituents, such as sodium hydroxide (NaOH). Other hydroxides that may be useful include lithium hydroxide (LiOH), potassium hydroxide (KOH), ammonium hydroxide (NH₃OH), calcium hydroxide (CaOH), magnesium hydroxide (MgOH), or combinations thereo. The alkaline treatment can be at a pH greater than about 7, more specifically at a pH greater than about 12. Without wishing to be bound by theory, it is believed that the alkaline treatment improves performance of the transparent conducting coating because the alkaline removes or otherwise degrades any nonconductive coating layers (such as polymer coatings) that may be on the conductive elements and that may adversely affect transparency and/or conductivity. The alkaline may be applied by, for example, brushing, painting, screen printing, stamp rolling, or spraying the alkaline onto the transparent conductive coating, dip-coating the coating into the alkaline, rolling the alkaline onto coating, or by any other method or combination of methods that permits the alkaline to be applied uniformly to the transparent conductive coating. In another exemplary embodiment of the invention, it will be understood that the alkaline can be added to the dispersion or the dispersion/binder combination before application to the substrate. After at least partial evaporation of the solvent, and any optional post-treatment, steps 24-30, and optionally 36, of method 20 can be repeated any suitable number of times so that additional layers of binder and dispersion can be applied, either separately or in combination, to the substrate. The layers can be, for example, of varying thickness, varying transparency, and/or varying conductivity.

After at least partial evaporation of the solvent and at least partial curing of the binder, and after any post-treatment, the substrate and the overlying transparent conductive coating are stretched (step 32). Stretching is carried out at a temperature which is lower than the melting point of the substrate but is higher than a low temperature at which cracks are formed on deformation. The substrate and the overlying transparent conductive coating can be stretched uniaxially or biaxially using any suitable conventional method that results in a decrease in a thickness of the resulting transparent conductor. In a preferred embodiment of the invention, the transparent conductive coating and substrate are stretched by a flat film stretching apparatus to avoid processing difficulties such as non-uniform thickness. For example, stretching may be performed by longitudinal stretching between differential rollers, lateral stretching by a tenter, simultaneous biaxial stretching by an accelerative tenter, and simultaneous polyaxial stretching by inflation. In addition to, or instead of, any post-treatment performed before stretching, the resulting transparent conductor can be post-treated to further improve the transparency and/or conductivity thereof.

### EXAMPLE

In an exemplary embodiment of the present invention, a 0.006 inch (0.15 mm) thick sheet of polypropylene (PP) having a light transmittance of 92.7% was provided. Approximately 0.016 grams (g) of single-walled carbon nanotubes in 0.50 g water were combined with 6.62 g of a 1.0 wt % aqueous solution of sodium dodecyl benzyl sulfate using a 500 watt horn sonicator set at 50% pulsed power mode (Sonics & Material Inc., Model VCX 500) for 30 minutes. The resulting dispersion was mixed with 2.86 g Stahl Product Code EX-66-866 in ajar roll mill for 5 minutes. The combination then was applied to the surface of the PP sheet using a #7 Mayer rod (wire wound coating rod). The combination was applied to a wet film thickness of approximately 18 μm. The assembly was heated to 80° C. for approximately 5 minutes to permit the solvent to evaporate and the binder to cure. The coated PP sheet had a light transmittance of 82.1% and a surface resistivity of 2×10¹⁰ Ω/sq. The resulting transparent conductive coating and the PP sheet were stretched together on a biaxial stretching machine from 3 inches (7.62 cm)×3 inches (7.62 cm) to 9 inches (22.86 cm) by 9 inches (22.86 cm). The resulting stretched transparent conductor was free of delamination and the transparent coating was seen to be uniformly distributed and adherent. The stretched transparent conductor had a light transmittance of 88.9% and a surface resistivity of 5×10¹¹ Ω/sq.

Accordingly, a transparent conductor having a stretched substrate and a stretched transparent conductive coating disposed on the substrate has been provided. A method for fabricating such a transparent conductor also has been provided. The use of conductive elements, such as nanowires and nanotubes, and, optionally, a stretchable binder permits the production of a stretched transparent conductor that operates consistently in high and low humidity conditions, does not result in loss of function over time due to changing vapor pressures, does not suffer from sloughing damage, and does not present contamination issues. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for fabricating a transparent conductor, the method comprising the steps of:
providing a stretchable transparent substrate;
forming a dispersion comprising a plurality of conductive elements and a solvent;
applying the dispersion overlying the stretchable transparent substrate;
at least partially evaporating the solvent from the dispersion to form a transparent conductive coating on the stretchable transparent substrate; and
stretching the stretchable transparent substrate and the transparent conductive coating.

2. The method of claim 1, wherein the step of forming the dispersion comprises the step of forming the dispersion comprising a plurality of carbon nanotubes, a plurality of metal or metal-comprising nanowires, a plurality of nanoparticles, or a combination thereof.

3. The method of claim 1, further comprising the step of applying a binder overlying the stretchable transparent substrate, the step of applying a binder performed before the step of at least partially evaporating the solvent.

4. The method of claim 3, wherein the step of applying a binder comprises the step of applying a binder comprising a material selected from the group consisting of polyurethanes, urethanes, polyisocyanurates, polyesters, polyolefins, polyvinyl chloride, polyvinylidene chloride, cellulose ester, polycarbonates, poly(vinyl acetate), poly(vinyl alcohol), acrylic and acrylate polymers, polyamides and polyimides, polyacetals, phenolic resins, aminoplastics epoxide resins, furan resins, silicones, casesin resins, and other cyclic thermoplastics, styrenic polymers, fluorine-containing polymers, polyethersulfone, and polyimides containing an alicyclic structure.

5. The method of claim 3, wherein, before the steps of applying the dispersion and applying the binder, the dispersion and the binder are combined and the dispersion/binder combination is applied to the stretchable transparent substrate so that the steps of applying are performed simultaneously.

6. The method of claim 3, wherein the step of applying the dispersion comprises the step of applying the dispersion onto the binder.

7. The method of claim 1, wherein the step of providing a stretchable transparent substrate comprises the step of providing a stretchable substrate having a light transmittance of no less than about 80%.

8. The method of claim 1, wherein the step of providing a stretchable transparent substrate comprises the step of providing a substrate comprising a material selected from the group consisting of polyesters, polyolefins, polyvinyls, polyvinylidene chloride, cellulose ester bases, polycarbonates, poly(vinyl acetate) and its derivatives, acrylic and acrylate polymers, poly(methyl methacrylate) (PMMA), methacrylate copolymers, polyamides and polyimides, polyacetals, phenolic resins, aminoplastics, epoxide resins, urethanes, polyisocyanurates, furan resins, silicones, casesin resins, and cyclic thermoplastics including cyclic olefin polymers, styrenic polymers, fluorine-containing polymers, polyethersulfone, and polyimides containing an alicyclic structure.

9. The method of claim 1, wherein the step of forming a dispersion comprising the plurality of conductive elements and the solvent comprises the step of forming a dispersion comprising a solvent selected from the group consisting of water, alcohols, ketones, acetates, ethers, hydrocarbons, aromatic solvents, toluene, hexane, dimethylformamide, tetrahydrofuran, n-methylpyrrolidone, propylene glycol monomethyl ether, and propylene glycol methyl ether acetate, and combinations thereof.

10. The method of claim 1, further comprising the step of adding to the dispersion a functional additive.

11. The method of claim 1, further comprising the step of pretreating the substrate with plasma treatment, a UV-ozone treatment, a flame or corona discharge, an adhesive, or a combination thereof.

12. The method of claim 1, further comprising, after the step of evaporating and before the step of stretching, the step of post-treating the transparent conductive coating with an alkaline.

13. The method of claim 1, further comprising, after the step of stretching, the step of post-treating the transparent conductive coating with an alkaline.

14. A composition for fabricating a stretchable transparent conductive coating on a stretchable substrate, the composition comprising:
a solvent; and
a plurality of carbon nanotubes suspended in the solvent.

15. The composition of claim 13, wherein the plurality of carbon nanotubes have an average length in the range of about 1 to about 10 μm.

16. The composition of claim 13, wherein the solvent comprises a material selected from the group consisting of water, alcohols, ketones, acetates, ethers, hydrocarbons, aromatic solvents, toluene, hexane, dimethylformamide, tetrahydrofuran, n-methylpyrrolidone, propylene glycol monomethyl ether, and propylene glycol methyl ether acetate, and combinations thereof.

17. The composition of claim 13, further comprising a stretchable binder.

18. The composition of claim 16, wherein the stretchable binder comprises a material selected from the group consisting of polyurethanes, urethanes, polyisocyanurates, polyesters, polyolefins, polyvinyl chloride, polyvinylidene chloride, cellulose ester, polycarbonates, poly(vinyl acetate), poly(vinyl alcohol), acrylic and acrylate polymers, polyamides and polyimides, polyacetals, phenolic resins, aminoplastics epoxide resins, furan resins, silicones, casesin resins, and other cyclic thermoplastics, styrenic polymers, fluorine-containing polymers, polyethersulfone, and polyimides containing an alicyclic structure.

19. The composition of claim 17, wherein the stretchable binder is a water-based polyurethane formed from an aliphatic polyester polyol and an aliphatic polyisocyanate.

20. The composition of claim 13, further comprising a functional additive.

21. A transparent conductor comprising:
a stretched substrate; and
a stretched transparent conductive coating overlying the stretched substrate.
